(19) United States
(12) Patent Application Publication
(10) Pub. No.: US 2007/0244773 A1
(43) Pub. Date: Oct. 18, 2007

(54) Method and System for Evaluating an Object or Obtaining Information From Operators

(75) Inventors: Thomas Hessler, Berlin (DE); Heiko Rauch, Berlin (DE); Jens Hewald, Markee (DE)

Correspondence Address: NIXON & VANDERHYE, PC, 901 NORTH GLEBE ROAD, 11TH FLOOR, ARLINGTON, VA, 22203, US

(73) Assignee: ZANOX.DE AG, Berlin (DE)

(21) Appl. No.: 11/576,783

(22) PCT Filed: Oct. 28, 2005
(86) PCT No.: PCT/EP05/11585

§ 371 Date: Apr. 5, 2007

(30) Foreign Application Priority Data
Nov. 8, 2004 (DE) DE 102004053794.1

(51) Int. Cl. G06Q 30/00

(52) U.S. Cl. 705/28; 705/27

(57) ABSTRACT

A method for evaluating an object is described which has steps such as the provision of at least an object type, an object market and an object group for the object; the classification of the object by means of the combination of object type, object market and object group; and the calculation of the estimation of the development of the object.

The following invention relates to a method and a system for evaluating an object. The following invention further relates to a method and a system for obtaining information from operators.

Previously, it has been practically impossible or difficult to establish both a precise evaluation of the commercial potential of a product and also at the same time a reliable estimate of the further development of this commercial potential.

With regard to this, in U.S. Pat. No. 6,526,440 a method and a system is described which evaluates documents, for example websites, the number of references to a document to be evaluated, for example links of other websites to a website to be evaluated, being in proportion to the popularity of the document, for example of the website. In a ranking list, the documents which are often referred to are placed before the documents which are referred to less often. The number of references is the only evaluation criterion here, however.

Previously, it was also known that website operators are paid, preferably once, by advertising vehicles for placing them on the website. There was therefore always the risk of weighing up to what point the previously invested payment gave a good return.

It is an objective of the present invention to be able to precisely evaluate a wide variety of objects by means of a plurality of evaluation factors, and at the same time to obtain a reliable estimate of the development of the objects.

A further objective of the present invention is to produce a method and a system which enables a user of the service to minimise his cost risk when installing content, preferably on websites, and to obtain e-commerce content, advertising vehicles and product data from operators.

A further objective of the present invention is to provide a method and a system which enables advantageous commercial interaction between the objects.

The objectives, which relate to the evaluation of objects and which relate to the commercial interplay between the objects are fulfilled procedurally by the features of Claim 1 and by a system with the features of claim 32.

The objective which relates to obtaining information from operators, is fulfilled procedurally with the features of Claim 38, and by a system with the features of claim 43.

According to the application, on the one hand a method for evaluating an object is described. Each object here belongs to an object market, to an object group, and compulsorily to an object type. By means of this 3-part allocation, one achieves very good grouping of the objects. For example, the commercial potential of objects in online sales can be determined and estimated for future development. Classification is provided by the combination of object type, object market and object group. It is defined as the grouping of objects by object type, object market and object group. The classification is connected to all information which is required for the specific evaluation of the objects grouped in it. This includes evaluation factors, an automatically produced optimal object and manually produced optimal objects, as well as a reference object. The classification is therefore used as an essential reference point for the evaluation. It is connected to the required pool of evaluation factors. Each object basically belongs to at least one classification. Objects evaluated in the same way are allocated to one classification. These objects in one classification are given the same evaluation criteria, are all of the same object type, are all considered for the same object market, and all belong to the same object group. The object type detail is therefore compulsory.

The precise calculation of the estimate of the development of the object is an essential feature of the present invention. Previously, it has not been possible to obtain such a reliable prognosis for an object in the commercial field. An example of objects are product search engines within the internet which compete with one another and can be precisely evaluated as regards their marketing quality using the present method, For example, product search engines are of the “advertising space/website” object type, in the same way as mobile telephone manufacturers are objects of the “mobile telephone manufacturer” object type. These advertising spaces can be in a classification which only has the object type=“advertising spaces/website” property, and so evaluates all advertising spaces to be found on the market by generally comparing them. Of course, in this classification other “advertising spaces/website” can also be found. This specific classification contains very specific evaluation criteria by means of the evaluation factors allocated to it.

According to the application, on the one hand a method and a system for obtaining information from operators is described. The user of a service is paid by the operators here dependently upon success. One application area for this, for example, is online co-operation business.

This method and system consist of a user who registers with a service provider and if successful, receives payment, an operator who receives an application from the user, and if approved sends the user confirmation by e-mail, and a service provider who acts as an intermediary between the user and the operator. Moreover, an advertising space is provided on which the user sets the link code to which he has access following confirmation from the operator. An advertising space can be a website, for example. Each advertising overlay (view), each click made (visitor), each lead (registration) and each sale (purchase) means success-related payment. Accounting and payment take place automatically.

Advantageous embodiments of the present subject matter of the application form the subject matter of the sub-Claims.

Claim 2 describes how the evaluation of the object is calculated by a comparison with the reference object. For each evaluation factor here, the comparison is advantageously implemented with a comparison algorithm. The specific values of the evaluation factors of an object in a classification established here from internal or external data sources are compared with the corresponding reference values of the reference object belonging to this classification.

According to Claim 3, the object to be evaluated can be a product, an individual or a service. Moreover, according to Claim 4, the object to be evaluated can be a business partner, a private partner, an advertising space, an advertising vehicle, an operator, a business or condition model. Therefore, one has a very wide band width for specifying the object to be evaluated.

According to Claim 5, with the help of prognosis algorithms which have been improved by an optimised development step, the further development with regard to the evaluation is estimated. There can be prognosis algorithms here, for example, with regard to season, temperature and time span.

For the evaluation, evaluation factors, an automatically produced optimal object, manually produced optimal objects and a reference object are required, as described in Claim 6. Great accuracy of the evaluation is made possible by this plurality of evaluation factors.

As disclosed in Claim 7, with the present method one has the two possibilities of initiating the evaluation both manually and automatically, and so the application possibilities are great. According to Claim 8, with an evaluation the values lie on a scale, preferably between 0 and 10. In this way one arrives at a simple and clear evaluation.

According to Claim 9, the object has the possibility of belonging to one or more classifications, the complexity of the evaluation being increased.

According to Claim 10 the classification is a clear combination of object type, object market and object group. By means of these 3 parameters, the classification can be described well. According to Claim 11, objects evaluated in the same way are allocated to one classification. Therefore, the classification includes the objects which are evaluated by comparison according to the same criteria. According to Claim 12, a prognosis component is allocated to the classification or to an individual component, and this can consist of several prognosis algorithms which have been improved by an optimised development step. For the calculation of the evaluation of an object, the prognosis algorithms contained in the prognosis component are run through. According to Claim 13, this prognosis is based either upon past values, in particular time and weather. It can be forecast, for example, that the enquiries relating to a specific object are made to a greater extent on weekdays in particular, in the period between 18.00 and 22.00. Or according to Claim 14, the estimate is based upon special events, the zeitgeist or the life cycle of an object. The life cycle gives information about the life cycle of an object and so shows to what extent the commercial potential of an object changes over time. Special events can clearly change a known enquiry curve. The zeitgeist also plays an important role and reflects how new fashions and changes to society have an effect upon the commercial potential of objects.

As shown in Claim 15, the object type is a clear property of an object and describes the type of objects to be evaluated. Each object must belong to an object type. For example, websites can be of the “advertising spaces/website” object type.

According to Claim 16, the object market is a property of the classification in which objects evaluated in the same way are combined. The object market specifies the market or the market platform in or on which the objects of a classification compete with one another. For example, objects of the “advertising spaces/website” object type can compete not only in the “worldwide” object market, but also in specific countries or regions. As well as this regional division of the market, a temporal division (for example “Christmas business”) and division of the market dependently upon climatic influential factors are conceivable.

According to Claim 17, the object group is a feature of the classification. Objects can be grouped by specifying an object group. One can for example sub-divide objects of the “websites” object type into the internet portals, online communities and product search engines object groups.

According to Claim 18, each evaluation factor receives an individual weighting percentage so as to thus show its influence upon the evaluation of the objects. The individual weighting can therefore be evaluated very precisely. The evaluation factors are seen as influential factors for the objects in a classification. Overall, the evaluation factors should give a true picture of the evaluation of objects. Moreover, for each evaluation factor, the maximum value (presetting 100%), which should be taken into consideration maximally for the evaluation, can optionally be set.

According to Claim 19 it is established that the sum of all weightings of an evaluation factor is 100 percent. With regard to a product, evaluation factors such as, for example, market share, sold units of a product or the image are interesting for a commercial potential.

According to Claim 21, these evaluation factors represent both statistical data and data which form the basis of the prognosis. In this way one covers a large spectrum of evaluation factors. An example of statistical data as evaluation factors are sold units of a product or clicks produced on a product search engine. An example of the use of data which form the basis of the prognosis is when due to a planned large image campaign with the corresponding product, it is concluded that future turnover will be higher, or when, by starting a far-reaching competition on the website of a product search engine, it is expected that there will be greatly increased consumer interest in the future, and so higher click rates. The data used for the classification for the individual evaluation factors originate from internal data sources (for example data from a manufacturer) or from external data sources (for example statistics, commercial information services), as described in Claim 20. One therefore covers these sources of data to be processed.

According to Claims 22 to 24, the aforementioned optimal object is produced from the data available on the market, with the established influential factors. In this way, the optimal object represents the market very well. It includes the optimal values of the respective influential factors. One has the choice of establishing the optimal object both automatically and also manually.

According to Claim 25, an automatically or manually produced optimal object is allocated to the reference object. Claim 26 discloses that the aforementioned reference object consists of all of the influential factors required for the evaluation. Unlike the optimal object, the value of the reference object can be a combination of values from the automatically and the manually produced optimal object. In this way, the reference object represents the market very well.

According to Claim 27, one advantageous embodiment of the present evaluation of objects is the possibility of graphically illustrating the evaluation of the objects to be evaluated and/or of the objects evaluated. By means of this illustration, the evaluations of the individual objects can be clearly compared.

Claims 28 and 29 describe a further embodiment of the subject matter of the application. Here, the present possibility of evaluating objects for a search engine is used, as the result of a search, the objects to be evaluated and/or the objects evaluated advantageously being displayed in a sequence. Search engines are used because these are favoured by internet service users. An example of an object to be evaluated is a product, and an example of the evaluation is the commercial potential.

A further embodiment according to Claims 30 and 31 is the use of the possibility of evaluating objects in order to produce a ranking list, the objects to be evaluated and/or the objects evaluated advantageously being indicated first if they have a higher evaluation.

According to Claim 32, a system for evaluating an object is disclosed. For the evaluation an administration module is made available. This greatly facilitates the administration of the evaluation.

A reproduction unit for displaying graphs is disclosed according to the application, and this enables direct observation of the graphs produced. These graphs can be flexibly adapted by means of calculation algorithms. It is possible here to use and combine exponential, logarithmic and other graphs. In this way, these can be well adapted to the different market factors.

The method according to the application has the two possibilities of accessing both external and internal data bases.

As disclosed in Claims 33 to 35, a new object can be created with the administration module, and be allocated to an existing object group. An existing object can be changed or deleted. A new classification can be created, changed or deleted. For a classification, evaluation factors can be chosen or be newly established from a list of existing evaluation factors. Existing classifications can be indicated. A new object market can be created, changed or deleted. All classifications which belong to the same object market can be indicated. A new object type can be created, changed or deleted. All classifications of an object type can be indicated. A new object group can be created. An existing group can be changed or deleted. All classifications with the same object group can be indicated. New evaluation factors can be established and defined. For each evaluation factor a calculation algorithm can be selected. The parameters for this algorithm can be set. The weighting of the evaluation factors and their maximum considered values can be indicated and changed. Existing evaluation factors can be allocated to a newly established or existing classification. New algorithms for the evaluation factors can be established, and existing ones changed or deleted. All algorithms can be indicated, and the graphs produced from them can be displayed. The optimal object can be automatically produced. An optimal object can be entered manually and be saved. The timings for the automated re-establishment of the automatically produced optimal object can be set individually for each classification. Previously established automatically produced optimal objects can be indicated for statistical purposes. Saved manually produced optimal objects can be reloaded and reused. A reference object can be newly established or changed. For this, for each evaluation factor as a reference value, either the value of the automatically produced optimal object or the value of a manually produced optimal object can be applied.

As described in Claim 39, success-related payment takes place individually depending on the operator, for advertising overlays (views), clicks made (visitors), leads (registrations) or sales (purchases). The payment can be for example a percentage of the turnover achieved. According to Claim 40 the advertising overlays are advantageously advertising banners which appear on a website. Payment can be made here for each successful transaction. For example, payment can be made for a click on the advertising banner of an advertising vehicle.

According to Claims 41 and 43, a user registers with a service provider, selects an operator and so submits an application to the latter. If the operator agrees to the co-operation, he sends the user confirmation, advantageously by e-mail. The user can now set up a link code on his advertising space. If successful, the user receives payment from the operator, for example 20% of the sales secured. A co-operation between the user and the operator is thus established with only low cost for both parties.

The information which the user receives from the operator can be e-commerce content, advertising vehicles or product data, as described in Claim 42. This information is paid for dependently upon success, i.e. if for example a product purchase or registration takes place with an operator.

The other advantageous embodiments of the present subject matter of the application form the subject matter of the further sub-Claims.

In the following, the method sequence for evaluating an object is described as an example.

An evaluation is to be calculated here for merchants (operators), here in particular five mobile telephony providers, without considering any particular market. The general data (name etc.) for the five mobile telephony providers are already provided in a data base. The evaluation relates to these data. As an example, mobile telephony provider V is considered.

1. Establish the Classification

1.1 An “all mobile telephony providers” classification with the “merchant” object type and the “mobile telephony provider” object group is newly established;

an object market is not considered.
1.2. A new reference definition, which will contain the configuration values for the reference, is established for the classification.
1.2.1. The evaluation exponent for this reference definition remains at standard 1.00.
1.3. Evaluation factors from a group of available evaluation factors are allocated to the reference definition.
1.3.1 The “turnover” evaluation factor is added to the reference definition.
1.3.1.1. This evaluation factor is weighted by 50%. The maximum value remains at standard 100%.
1.3.2. The “number of sales” evaluation factor (in this case mobile phone contracts, Call Ya, . . .) is added to the reference definition.
1.3.2.1. This evaluation factor is weighted by 30%. The maximum value is set at 150%.
1.3.3. The “annual advertising budget” evaluation factor is added to the reference definition.
1.3.3.1. This evaluation factor is weighted by 20%. The maximum value remains at standard 100%.
   2. Add Objects (Repeated for Four Further Providers)
2.1. Mobile telephony provider V is allocated as an object to the “merchant” object type.
2.2. V is allocated to the newly established “all mobile telephony providers” classification.
   3. Establish the Bases for Calculation
3.1. The performance values for all mobile telephony providers in this classification are established for the first time and saved.
3.1.1. In order to establish the performance values, an individually selectable period is taken into consideration, but data for the past three months at least must be established.
3.2. An optimal object is produced automatically (effectively the ideal mobile telephony operator).

The following values were established: “turnover” optimal value=100 million euros/“number of sales” optimal value=4.5 million (pieces)/“advertising budget” optimal value=12 million euros.
3.3. An optimal object is established manually with the name “provider_{—}01”.
3.3.1. For the “turnover” evaluation factor, the standard value (value of the automatically established optimal object) is kept.
3.3.2. For the “number of sales” evaluation factor, a value of 4 million (pieces) is set.
3.3.3. For the “advertising budget” evaluation factor, a value of 1 million (euros) is set.
3.4. In the reference definition, two optimal objects are entered as sources for reference values.
3.4.1. The automatically produced optimal object is already entered as the first optimal object and can not be changed.
3.4.2. The manually produced “provider_{—}01” optimal object is selected and entered as the second optimal object.
3.5. In the reference definition the source of the reference values is set for each evaluation factor.
3.5.1. For the “turnover” evaluation factor, the automatically produced optimal object is entered as the source.
3.5.2. For the “number of sales” evaluation factor, the manually produced optimal object is entered as the source.
3.5.3. For the “advertising budget” evaluation factor, the automatically produced optimal object is entered as the source.
   4. Prognosis
4.1. A prognosis component is allocated to object V as the only object.
4.1.1. The “time” prognosis algorithm with the “months” grid is first of all allocated to the prognosis component.
4.1.2. Secondly, the “time” prognosis algorithm with the “season” grid is allocated to the prognosis component.
   5. Input Performance Values
5.1. All of the evaluation factors which are used by the “merchant” object type are established.
5.1.1. For all of the objects of the “merchant” object type, the performance values for these evaluation factors are established and saved.
   6. Input Definitions
6.1. For the “all mobile telephony providers” classification with the “merchant” object type and the “mobile telephony provider” object group, the reference definition is established.
6.1.1. The evaluation factors defined for this reference definition are established.
   7. Calculate Evaluation (Repeated for Four Further Providers)
7.1. For V, the performance value for the “turnover” evaluation factor is input (example: 100 million euros).
7.1.1. The value is compared with the reference value from the automatically produced optimal object (example: 100 million euros).
7.1.2. For this, the comparison algorithm of the evaluation factor is used. The result is 1.00 (simple ratio comparison for this example: 100 million/100 million=1).
7.2. For V, the performance value for the “number of sales” evaluation factor is input (example: 4.4 million pieces).
7.2.1. The value is compared with the reference value from the manually produced “Provider_{—}01” optimal object (example: 4 million pieces).
7.2.2. For this, the comparison algorithm of the evaluation factor is used. The result is 1.10 (because consideration up to 150% possible; simple ratio comparison for this example: 4.4 million/4 million=1.1).
7.3. For V, the performance value for the “advertising budget” evaluation factor is input (example: 3 million euros).
7.3.1. The value is compared with the reference value from the automatically produced optimal object (example: 12 million euros).
7.3.2. For this, the comparison algorithm of the evaluation factor is used. The result is 0.25 (simple ratio comparison for this example: 3 million/12 million=0.25).
7.4. The individual results are weighted for V with the set weightings and added up.
7.4.1. In this example the result is 0.88 and is saved as an evaluation value.

Evaluation value: (1*0.5)+(1.1*0.3)+(0.25*0.2)=0.88

8. Establish the Evaluation (Repeated for Four Further Providers)

8.1. The value of the evaluation for V is inserted into the evaluation algorithm with an evaluation exponent of 1.00.
8.1.1. The result for this example is an evaluation of 8.8 which can now be displayed.

This evaluation only relates to the “all mobile telephony providers” classification, and is used to compare the mobile telephony providers with one another. It can not be used to compare with merchants of other classifications because these may have been evaluated using totally different criteria.

9. Analysis of Past Values

9.1. A prognosis component is allocated to object V.
9.2. The prognosis algorithms of the prognosis component are established.
9.3. For the “time” prognosis algorithm with the “months” grid, the past values are analysed.
9.3.1. The results are saved in a value table.
9.4. For the “time” prognosis algorithm with the “season” grid, the past values are analysed.
9.4.1. The results are saved in a value table.
   10. Calling Up a Prognosis
10.1. For object V the evaluation development for the next six months should be forecast.
10.2. The current month is established.
10.3. The value table for the desired prognosis is input (“time” prognosis algorithm with the “months” grid).
10.4. The development for the other 11 months is set in relation to the current month according to the value table.
10.5. By means of these relationships, the evaluation for the next months is shown upon the basis of the current evaluation.

After the general description of the evaluation of an object, by means of the following account, a further application of the subject matter according to the application will be described. For this, the objects being evaluated, for example several partners within an object market or a network with a specific classification, are given the possibility of asking for offers. For this, partners are listed with their advertising spaces in a so-called partner/offer catalogue. Both partners and operators can submit offers. Here, with regard to the partner profile the operator can see an anonymous list of the currently existing offers and the current performance of the object being considered. The offers can be responded to by acceptance, rejection or by a counter-offer. The possibility of asking for offers is only made available to the objects which achieve a certain evaluation or a certain so-called AdRank (for example>=6.0) or are made available for this. With regard to this, it is also possible to allow the operator only limited access to the partner/offer catalogue upon request. It can therefore be checked whether the marketing areas or categories of both parties correspond. Whether a partner appears with his advertising space in the partner/offer catalogue is dependent upon whether he achieves the corresponding AdRank (for example>=6.0). This can be influenced temporally and with a level limit. An object is therefore also given the possibility of participating in the offer negotiations at an earlier stage. If the partner is omitted from the partner/offer catalogue because he no longer meets the criteria, existing or previous offers are nevertheless indicated for the respective operators.

The partner/offer catalogue can be filtered using parameters such as, for example, offer status, offer period, partner name or website, minimum or maximum free views or clicks, and the category in which the partner has placed himself. The partner/offer catalogue gives an overview of information about current offers and the relationship to the object (“advertising space”). By means of the partner/offer catalogue the operator gains access to the relevant partner information and the respective offer page. The offer page once again contains information on the object or offer, the current offer or counter-offer—if available—and the history of the offer. By means of a standardisation, an existing condition model can be selected or special conditions can be included. By means of an information display, additional information can be exchanged. The prerequisites for a relationship being established between the objects are not effected by the process described here. Offers are communicated to the respective object by conventional communication means, preferably by e-mail. The operator sees the offer in the partner/offer catalogue and the partner information.

The partner sees the offer input in an overview made available to him and the detailed information on the object. By means of this overview, or also by means of the object information, the respective partner can decide what he wants to do with the offer. Every current offer can be seen again on a particular offer page. Here, relevant data with regard to the object, the offer and the submission of a counter-offer are shown. By means of an information field, if appropriate further offer details can be exchanged. Here too there is an examination of the prerequisites for the relationship between the objects coming into being. If these are not fulfilled, the offer can not be accepted. A counter-offer can always be submitted.

The operator learns the reaction to his offer via conventional communication means, preferably via e-mail and via the partner/offer catalogue. The partner can see his counter-offers in his offer overview. If an offer is accepted without reservation, a business relationship is established immediately, and the objects can administer this as normal. New offers can be made at any time.

For the issue of offers, as well as the normal object information, the following information is added, and firstly: free views and free clicks, secondly the detailed comparison of the current offer and counter-offer, thirdly the history of all offers and counter-offers, fourthly and optionally, the current performance of the object being considered (total of the views, clicks, leads, sales, click through rate, click lead rate, click sale rate as a total for the last week and the last month), and fifthly, the competing offers currently open to the partner, such as for example a presentation of the conditions, listed anonymously, but with the category of the party making the offer.

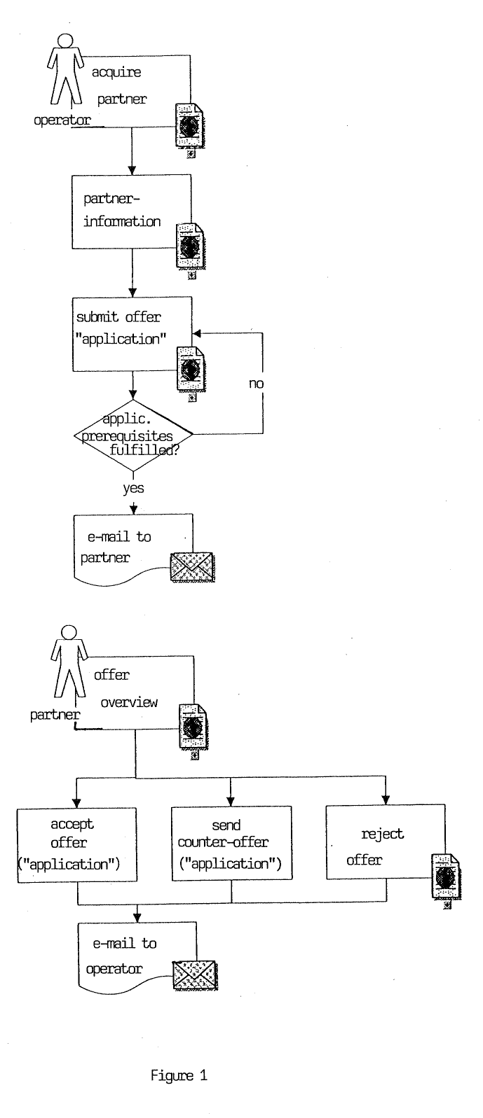

By means of FIG. 1 the method described above is illustrated as an example. For this, a selected number of partners and objects is provided which were acquired, for example, by an operator. By means of the previously evaluated partners, partner information is brought together by the operator, and this is preferably collected in a standardised way. The operator then prepares and submits to these partners an offer—a so-called application—which includes certain application prerequisites. If the application prerequisites are not fulfilled, in accordance with the flow diagram a modified application is then produced. If the application prerequisites are fulfilled, the corresponding partner is informed by means of a conventional communication means, for example e-mail, that he has fulfilled the application prerequisite. An offer overview is then made available to the selected and evaluated partner. Each partner then has the possibility of either accepting the offer or submitting a counter-offer, or rejecting the offer. Each of the possibilities implemented are made known to the operator who can register the possibility selection and both the partners and himself as the operator can offer.

With the subject matter according to the application it is therefore possible to provide a platform both for objects and for operators and objects by means of which effective exchange of information for commercial success and a clearly structured selection process for prospective business partners is possible.

1. A method for evaluating an object comprising:
a) providing at least an object type, an object market and an object group for the object,
b) classifying the object by means of the combination of object type, object market and object group,
c) calculating the evaluation of the development of the object.

2. The method according to claim 1, further comprising the calculation of the evaluation of the object being implemented by means of a comparison with a reference object.

3. The method according to claim 1, the object being a product, an individual or a service.

4. The method according to claim 1, the object being a business partner, a private partner, an advertising space, an advertising vehicle, an operator, a business or condition model.

5. The method according to claim 1, the estimation of the development of the object being calculated with the help of prognosis algorithms.

6. The method according to claim 1, the evaluation being implemented by means of evaluation factors, an automatically produced optimal object, manually produced optimal objects and a reference object.

7. The method according to claim 1, the evaluation being produced manually and/or automatically.

8. The method according to claim 1, the evaluation adopting values from a value scale, preferably between 0 and 10.

9. The method according to claim 1, the object belonging to one or more classifications.

10. The method according to claim 1, the classification being a clear combination of object type, object market and object group.

11. The method according to claim 1, objects evaluated in the same way being allocated to one classification.

12. The method according to claim 1, a prognosis component, which consists of several prognosis algorithms, being allocated to the classification and/or to a single object.

13. The method according to claim 1, the estimation of the development being based upon past values, in particular time and weather.

14. The method according to claim 1, the estimation of the development with regard to special events, the zeitgeist or the life cycle of an object being possible.

15. The method according to claim 1, the object type being a clear property of an object.

16. The method according to claim 1, the object market being a property of the classification.

17. The method according to claim 1, the object group being a feature of the classification.

18. The method according to claim 1, each evaluation factor receiving an individual weighting percentage.

19. The method according to claim 18, the sum of all weightings being exactly 100 percent.

20. The method according to claim 1, the evaluation factors representing both statistical data and data which form the basis of the prognosis.

21. The method according to claim 1, the data regarding the individual evaluation factors used for the classification originating from internal data sources and/or from external data sources.

22. The method according to any of claim 1, the optimal object being produced from the data available on the market with the established pool of evaluation factors.

23. The method according to claim 1, the optimal object including the optimal values of the respective influential factors.

24. The method according to claim 1, the optimal object being established automatically, and preferably also manually.

25. The method according to claim 1, an automatically and/or manually produced optimal object being allocated to the reference object.

26. The method according to claim 1, the reference object consisting of all of the influential factors required for the evaluation.

27. The method according to any of claim 1, the evaluation of the objects to be evaluated and/or of the objects evaluated being illustrated graphically.

28. The method according to claim 1, the different evaluations of objects being used for a search engine.

29. The method according to claim 28, as a result of a search of the search engine, the objects to be evaluated and/or the objects evaluated being displayed in a sequence.

30. The method according to claim 1, the different evaluations of objects being used to produce a ranking list.

31. The method according to claim 30, the objects to be evaluated and/or the objects evaluated for the ranking list preferably being indicated first if they have a higher evaluation.

32. A system for evaluating an object, in particular for implementing the method according to claim 1, comprising:
a) an administration module for the evaluation,
b) a reproduction unit for displaying graphs,
c) an external and internal data base for providing data by means of which the evaluation is implemented.

33. The system according to claim 32, objects, evaluations, classifications, object markets, object types, object groups, evaluation factors and/or prognosis algorithms being processed, changed and deleted with the administration module.

34. The system according to claim 32, an optimal object being automatically produced, manually entered, saved and deleted with the administration module.

35. The system according to claim 32, a reference object being newly produced, changed, saved and deleted with the administration module.

36. The system according to claim 32, a search engine being provided which uses the different evaluations of objects.

37. The system according to claim 36, as a result of a search of the search engine, the objects to be evaluated and/or the objects evaluated being displayed in a sequence.

38. The method for obtaining information from operators, in particular according to claim 1, which pay users of a service dependently upon success.

39. The method according to claim 38, the payment taking place individually, depending on the operator, for advertising overlays (views), clicks made (visitors), leads (registrations) or sales (purchases).

40. The method according to claim 39, the advertising overlays being used as advertising banners on a website.

41. The method according to claim 38:
a) a user registering with a service provider,
b) the user selecting an operator,
c) the user applying to the operator,
d) if approved, the user receiving confirmation from the operator by e-mail,
e) the user setting up a link code on his advertising space to which he has access following confirmation,
f) if successful, the user receiving payment.

42. The method according to claim 38, the information consisting of e-commerce content, advertising vehicles and product data.

43. A system for obtaining information from operators which pay users of a services dependently upon success, in particular for implementing the method according to claim 1, comprising:
a) a user who registers with a service provider and, if successful receives payment,
b) an operator who receives an application from the user and, if approved, sends confirmation to the user by e-mail,
c) a service provider who acts as an intermediary between the user and the operator,
d) an advertising space on which the user sets up the link code to which he has access following confirmation from the operator.

44. The method, in particular according to claim 1, the objects forming a partnership if the respective evaluation of the objects lies above a prespecified value—a so-called adrank value.

45. The method according to claim 44, the objects being listed in a partner catalogue.

46. The method according to claim 44, it being possible for an operator to submit an offer to the partners.

47. The method according to claim 46, the offer being accepted, rejected or being responded to with a counter-offer.

48. The system, in particular according to claim 1, the objects forming a partnership if the respective evaluation of the objects lie above a prespecified value—a so-called adrank value.

49. The system according to claim 48, the objects being listed in a partner catalogue.

50. The method according to claim 48, it being possible for an operator to submit an offer to the partners.

51. The method according to claim 50, the offer being accepted, rejected or responded to with a counter-offer.
